(19) United States
(12) Patent Application Publication
(10) Pub. No.: US 2015/0375332 A1
(43) Pub. Date: Dec. 31, 2015

(54) NON-CONTACT LAMINAR FLOW DRAWN ARC STUD WELDING NOZZLE AND METHOD

(71) Applicant: NEWFREY LLC, Newark, DE (US)

(72) Inventors: Keegan James Dillon, Royal Oak, MI (US); Brendan Charles Kenyon, Utica, MI (US); Paul Michael Gianferrara, Armada, MI (US)

(73) Assignee: NEWFREY LLC, Newark, DE (US)

(21) Appl. No.: 14/753,652

(22) Filed: Jun. 29, 2015

Related U.S. Application Data
(60) Provisional application No. 62/019,276, filed on Jun. 30, 2014.

(51) Int. Cl. B23K 9/29; B23K 9/20

(52) U.S. Cl. CPC B23K 9/291; B23K 9/20

(57) ABSTRACT

A plurality of screens can be supported within a nozzle assembly and positioned so that gas from a housing manifold flows through the plurality of screens and into a flash shield nozzle. The flash shield nozzle can include a partial-parabolic-shaped portion. A distal end of a collet holding the stud during welding can extend past the distal end of the flash shield nozzle and any other component of the nozzle assembly to maintain a gap between a workpiece the stud is being welded to and the nozzle assembly so that no component of the nozzle assembly contacts the workpiece during stud welding. Related methods can include welding a stud to a workpiece including an obstruction or welding impediment.

### CROSS-REFERENCE TO RELATED APPLICATIONS

This application claims the benefit of U.S. Provisional Application No. 62/019,276, filed on Jun. 30, 2014. The entire disclosure of the above application is incorporated herein by reference.

### FIELD

The present disclosure relates to welding nozzles, and particularly, to a non-contact welding nozzle for drawn arc welding a stud to a part.

### BACKGROUND

This section provides background information related to the present disclosure which is not necessarily prior art.

Typically, studs are welded to a part using a welding nozzle that contacts and/or seals against the part to enclose the stud or welding area within a sealed chamber containing shielding welding gas, such as argon. FIG. 10 a similar view to that of FIG. 1, but showing a prior design where a flash shield makes contact with or seals against the part, during the welding process. To be clear, this contact or sealing occurs during at least the pilot arc and main arc generating operations (not just the final stud plunging operation). As a result of this contact or sealing is necessary to adequately retain the shielding gas during drawn arc stud welding.

### SUMMARY

This section provides a general summary of the disclosure, and is not a comprehensive disclosure of its full scope or all of its features.

In accordance with one aspect of the present disclosure, a drawn arc stud welder nozzle assembly can include a housing supporting a collet and defining a manifold including a plurality of gas passages through the housing. A flash shield nozzle can be releasably coupled to the housing and surrounding the collet. The flash shield nozzle can include an interior surface having a partial-parabolic-shaped portion. A plurality of screens can be supported within the nozzle assembly and positioned so that gas from the manifold flows through the plurality of screens and into the flash shield nozzle. The collet member can be structured to retain a weld stud during drawn arc welding. A distal end of the collet member can extend past the distal end of the flash shield nozzle and any other component of the nozzle assembly to maintain a gap between a workpiece to which the stud is being welded and the nozzle assembly.

In accordance with another aspect of the present disclosure a drawn arc stud welder method can include welding a stud held within a collet of a drawn arc stud welder nozzle assembly to a workpiece defining an impediment. The impediment can be a lateral distance of less than about 20 millimeters from a central axis of the stud during welding. The impediment can be one of an outside edge or convex surface, an inside corner or concave surface, and a second stud previously welded to the workpiece. During the welding the stud, a shielding welding gas can be passed through a plurality of screens and then into and through a flash shield nozzle surrounding the stud being held within a collet of a drawn arc stud welder nozzle assembly. The method can also include maintaining a gap between the workpiece and the nozzle assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of one exemplary welding nozzle assembly of a drawn arc stud welder welding head in accordance with the present disclosure.

FIG. 2 is an enlarged partial cross sectional view of FIG. 1.

FIG. 3 is a cross-sectional view showing the shielding welding gas flow paths through the nozzle assembly of FIG. 1.

FIG. 4 is a simplified perspective view of FIG. 4, a drawn arc stud welder with a welding head including the welding nozzle of FIG. 1.

FIG. 5 is a cross-sectional view of another exemplary welding nozzle assembly of a drawn arc stud welder welding head in accordance with the present disclosure, wherein the flash shield has a partial-parabolic shape.

FIG. 6 is a cross-sectional view similar to FIG. 1 and including the probe, workpiece and gap when the stud is plunged into molten material of the workpiece.

FIG. 7 is a cross-sectional view similar to FIG. 6 and including the probe, workpiece and gap when the stud is moved relative to the workpiece.

FIG. 8 is a cross-sectional view of yet another exemplary welding nozzle assembly of a drawn arc stud welder welding head in accordance with the present disclosure.

FIG. 9 a cross-sectional view showing the shielding welding gas flow paths through the nozzle assembly of FIG. 8.

FIG. 10 is a cross-sectional view of a prior welding nozzle where a flash shield makes contact with or seals against the part, during the welding process.

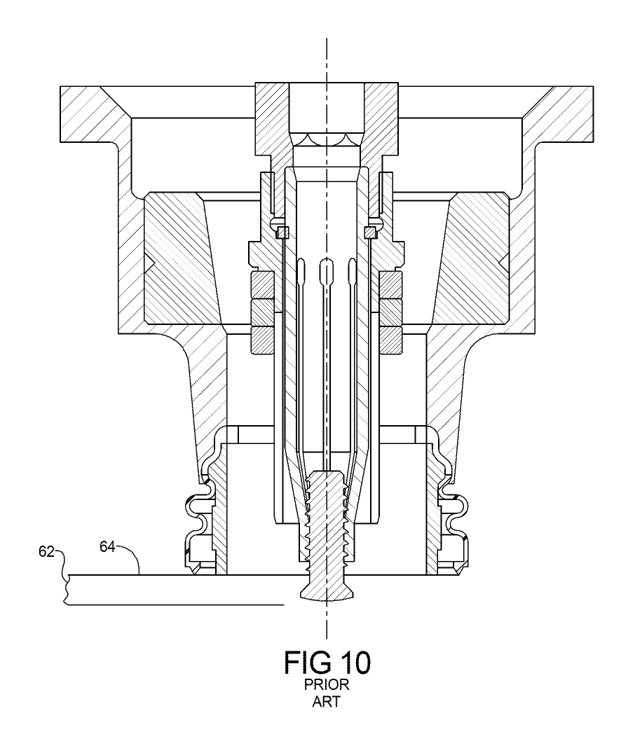

Corresponding reference numerals indicate corresponding parts throughout the several views of the drawings.

### DETAILED DESCRIPTION

Example embodiments will now be described more fully with reference to the accompanying drawings.

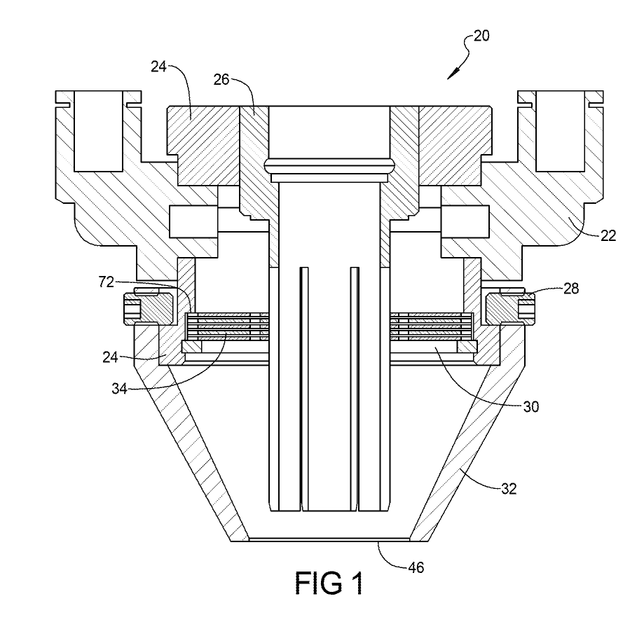

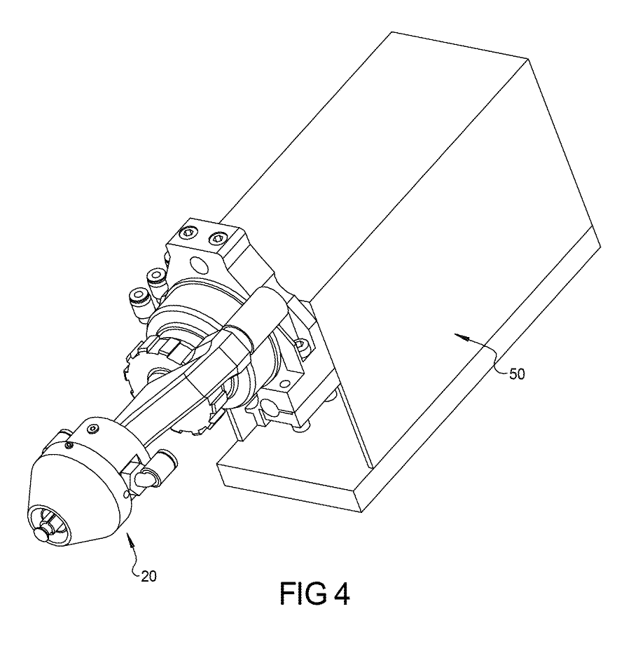

FIG. 1 illustrates one exemplary welding nozzle assembly 20 in accordance with the present disclosure. As seen in FIG. 4, the welding nozzle assembly is coupled to, or a component of, a welding machine 50 such as a drawn arc stud welder. The welding nozzle assembly 20 includes gas fittings 22 that are coupled to a shielding welding gas source (not shown). Also included is a flash shield collar or housing 24, collet 26, set screw 28, snap-ring 30, and flash shield 32. In addition, a series of annular screens 34 can be separated by spacers 36. As discussed below, the screens 34 operate to convert the initial turbulent flow of the shielding welding gas into a laminar flow state.

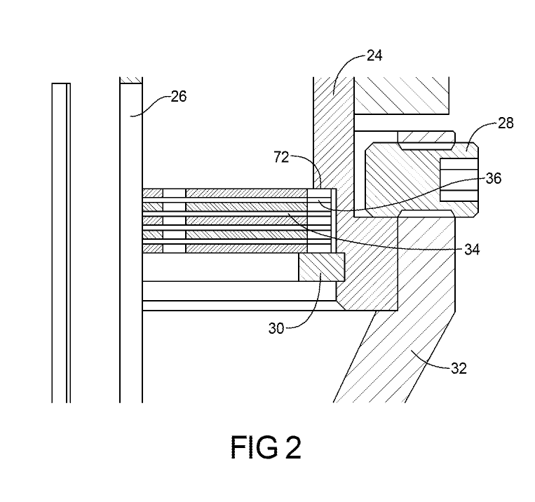

FIG. 2 illustrates one example of a set or series of screens 34 that are separated by spacers 36. In the illustrated example, the first three screens 34 encountered by the shielding welding gas can be 120 mesh screens. A fourth or last screen 34 encountered by the shielding welding gas can be a 180 mesh screen or a 165 mesh screen. Thus, the first three screens 34 can have screen size openings that are larger than the screen size openings of the final screen 34. The screens 34 can be separated from each other by about 0.5 mil. This separation can be provided by interposing 0.5 mil spacers 36 between the screens 34. In the illustrated example, five spacers 36 sandwich the four screens 34. Such screens can be purchased, for example, from McMaster-Carr of Aurora, Ohio using part numbers 85385T103 for 120 mesh screens and 85385T107 for 180 mesh screens. Of course, alternatives to the specifics detailed above or elsewhere herein can be varied in alternative embodiments without departing from the scope of the disclosure.

As illustrated, a first side of the plurality of screens 34 can be retained against an internal annular step 72 of the nozzle assembly 20. In this case, a housing component 24 can provide the internal annular step 72. The snap ring 30 can be positioned against a second, or opposite side of the screens 34 to retain the screens, with spacers 36 therebetween, against the step 72. The snap ring 30 can be retained within an annular recess or groove provided by the same housing component 24. The flash shield nozzle 32 can be releasably coupled to the housing component 24. Thus, the flash shield nozzle 32 can be uncoupled from the housing component 24 to allow access to the screens 34 for removal and replacement thereof.

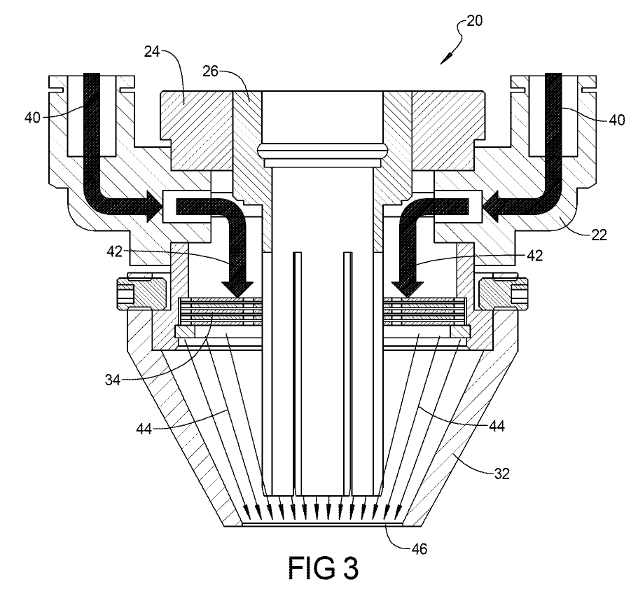

FIG. 3 illustrates the shielding welding gas flow path through the nozzle assembly 20. The shielding welding gas, which can be inert, enters the nozzle assembly through the gas fittings 22 as indicated by arrows 40. Thus, the gas fittings 22 define a manifold including a plurality of passages 40 through the housing 24. The inert gas enters an annular chamber upstream of the screens 34 as indicated by arrows 42. Although the inert gas flow is indicated by arrows 40 and 42, this pre-screen inert gas flow 40 and 42 is in a turbulent flow state. As the inert gas passes through the set or series of screens 34 the inert gas flow is converted to a laminar flow state as indicated by arrows 44.

The screens 34 can create a resistance or back-pressure which can reduce the flow rate of the inert gas through the nozzle assembly 20. Thus, a flash shield 32 or similar component of the nozzle assembly 20 can have a truncated conical shape as illustrated. In this way, the flash shield 32 can increase the velocity or density of the reduced flow rate inert gas exiting the nozzle assembly 20 without significantly disrupting the laminar flow. The exiting velocity and flow rate density (or area of the exit orifice 46) of the inert gas is sufficient to provide a column, zone, or curtain of inert gas that prevents ambient air from entering the welding zone. Thus, the exiting inert gas column, zone, or curtain surrounds or encompasses the stud or welding area to keep ambient air from entering the welding zone without the need for the nozzle assembly 20 to contact or seal against the stud or part to which the stud is being welded.

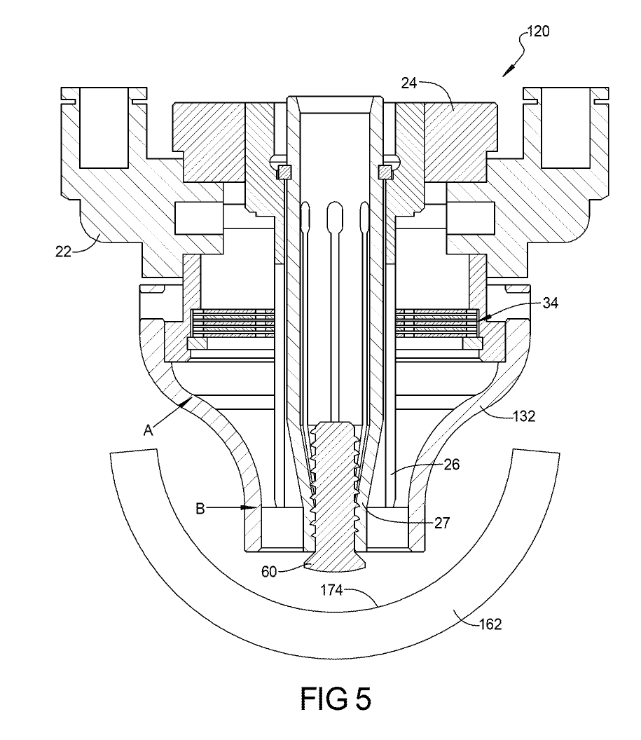

FIG. 5 illustrates an alternative nozzle assembly 120 where the flash shield inner surface has a partial-parabolic shape. The partial-parabolic shape surface can extend from point “A” to point “B” as seen in FIG. 5. For example, the partial parabolic shape can approximate or equal a half-parabolic shape. A partial-parabolic shaped exit nozzle or flash shield 132 can be particularly beneficial in forming an exiting column of inert gas with good laminar flow, and with sufficient flow rate, gas density or area to encapsulate the welding zone, including the stud 60, within an ambient air-free zone of inert gas.

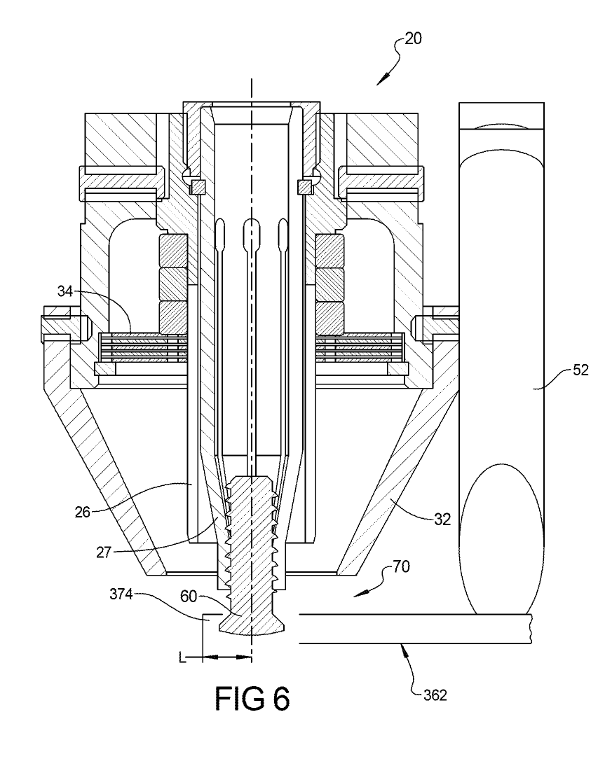

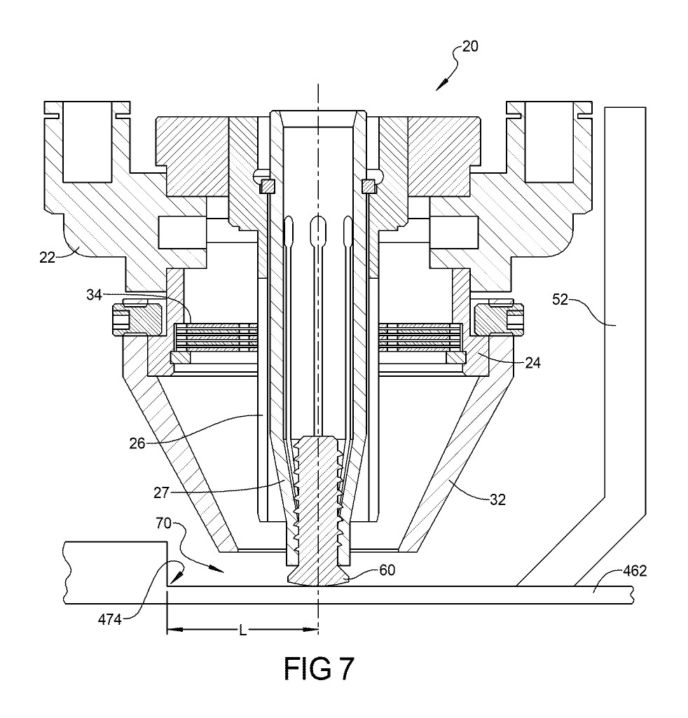

Although not shown in all the figures, not only can the collet include an outer collet 26, but also an inner collet 27 that holds the stud 60 during the welding operation as also seen in FIGS. 6 and 7.The outer collet 26 can comprise simply a collet nut (top portion), or can additionally include the downwardly extending fingers as illustrated in the drawings.

Referring to FIG. 7, the welder can include a contact probe 52 that holds the surface of the material or part 62. As shown in FIG. 7, the contact probe 52 can be angled toward the collet at its distal end so that it contacts the workpiece or part 62 within the overall or outside diameter of the flash shield nozzle 32. The stud 60 can also contact the surface 64 of the part 62 as shown. While the contact probe 52 remains in contact with the part 62, the nozzle and stud 60 can be moved away from the surface to draw a pilot arc. Thereafter, the main welding current can be turned on to generate a main welding arc creating molten material at the bottom of the stud 60 and at the surface of the base material or part 62. The stud 60 can then be plunged into the molten material or part 62 as suggested in FIG. 6.

There is no need throughout the welding process to contact the end of the nozzle or flash shield 32 to the material or part 62. For example, gap 70 can exist between the end of the nozzle 32 and the surface 64 of part 62 during the generation of the pilot and main arcs. The gap 70 can exist during the initial contact of the stud 60 and probe 52 to the part 62 as seen in FIG. 7. The gap 70 can exist during the final step of plunging the stud 60 into molten material of part 62. In other words, the gap 70 can also exist during any combination of the described process operations, and even throughout the entire drawn arc welding process.

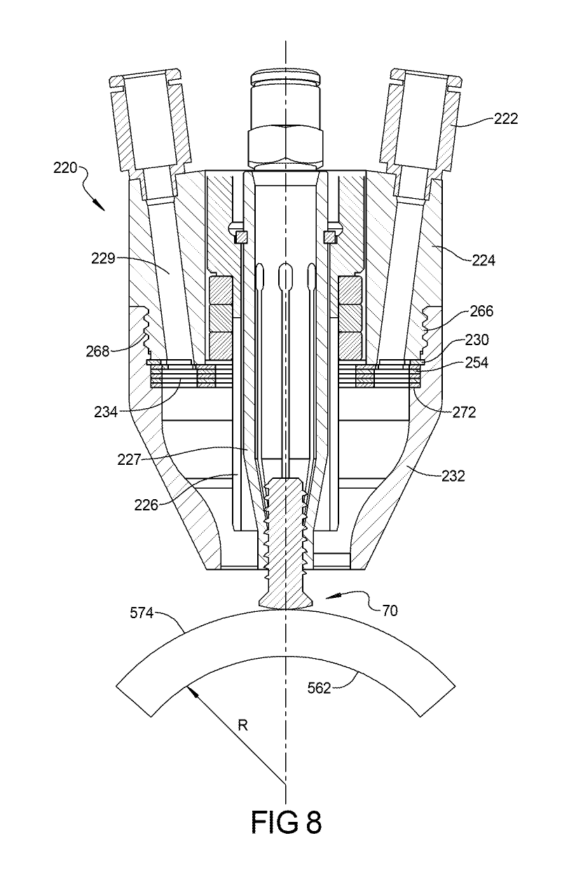

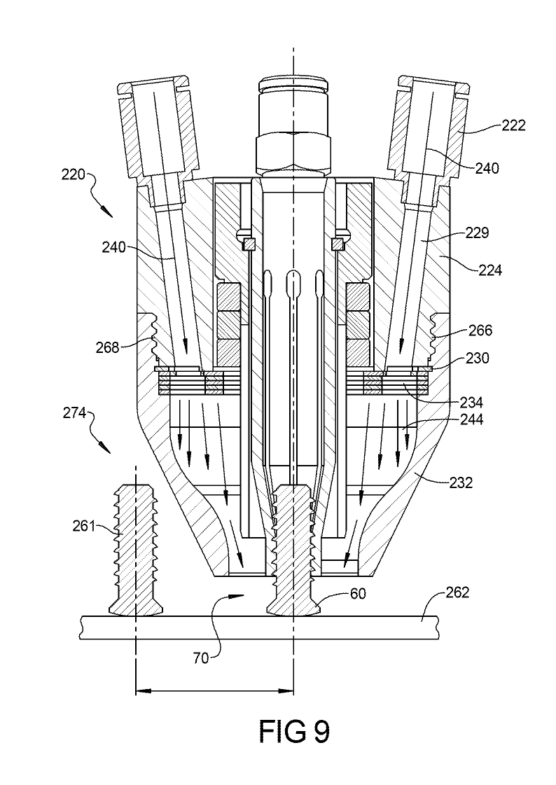

FIGS. 8 and 9 illustrate another alternative nozzle assembly 220 embodiment. As with the prior embodiment 120, the inner surface of the flash shield nozzle 232 can include a partial-parabolic shape. The housing 224 can support the inner collet 227 and the outer collet 226. An outer circumferential surface of the housing component 224 can include threads 266. An inner circumferential surface of the flash shield nozzle 232 can include cooperating threads 268, which engage against the threads 268 of the housing 224 to releasably couple the flash shield nozzle 232 to the housing 224.

As with the other embodiments, the screens 234 are retained on one side against an internal annular step 272 of the nozzle assembly 220. In this case, the flash shield nozzle 232 can provide the internal annular step 272. The snap ring 230 can be positioned against a second, or opposite side of the screens 34 to retain the screens, with spacers therebetween, against the step 272. The snap ring 230 can be retained within an annular recess or groove that is also provided by the flash shield nozzle 232. The screens 234 can have an annular shape surrounding the collet 26.

The flash shield nozzle 232 can be rotated about its central axis to disengage the cooperating threads 266 and 268 from each other and unscrew the nozzle 232 from the housing 224. Thus, the screens 232 can be removed from the housing 224 of the nozzle assembly 220 together with the flash shield nozzle 232. This permits the unscrewed sub-assembly to be readily moved to a convenient location, facilitating removal and replacement of the screens 234.

FIG. 9 illustrates the inert gas flow path through the nozzle assembly 220. The inert gas enters the nozzle assembly through the gas fittings 222 as indicated by arrows 240. Thus, the gas fittings 222 and passages 229 through the housing 224 define a manifold. The inert gas exits the passages 229 closely adjacent the screens 234 as indicated by arrows 240. This pre-screen inert gas flow 240 is in a turbulent flow state. As the inert gas passes through the set or series of screens 234 the inert gas flow is converted to a laminar flow state as indicated by arrows 244, similar to that described previously with respect to FIG. 3.

Each of the flash shield nozzles 32, 132, 232 described herein, including any partial-parabolic shaped inner wall portions can be made of any one or combination(s) of a non-conductive material, a high temperature resistant material, a rigid material, a moldable plastic material, a material including fiber reinforcements, such as carbon fiber reinforcements. As for high temperature resistance, in some cases the material should be capable of withstanding a temperature of at least 160 degrees F. during welding, or at least 450 degrees F. during welding, or at least 600 degrees F. during welding. One exemplary material which can combine many of these aspects is polyetheretherketone, which is commercially available, for example, from Ensinger Inc., of Washington, Pa., under the trade name, Tecapeek™. Other exemplary materials combining many of these aspects include various ceramic materials.

Many drawn arc stud welding methods should be apparent from the discussion herein. For example, such methods can include providing any of the components or features discussed herein in any combination for a nozzle assembly 20 for a drawn arc stud welder 50. Methods can additionally include maintaining a gap 70 or non-contact arrangement between the workpiece 62 and the nozzle assembly 20 during the entire welding operation. Methods can also include unscrewing or uncoupling the flash shield nozzle 32 from the housing 24 defining the manifold to enable sufficient access to the screens 34 to permit their removal and replacement. Such a method can include supporting the screens 234 via the flash shield nozzle 232 and removing the screens 234 from the manifold 224 along with the flash shield nozzle 232. Then the screens 234 can be removed and replaced within the flash shield nozzle 232 while it is uncoupled from the housing 224.

Drawn arc stud welding methods can further include welding a stud 60 held within a collet 26 and 27 of a drawn arc stud welder nozzle assembly 20 to a workpiece 62 defining an impediment 74 that is in some cases a lateral distance of less than about 20 millimeters from a central axis of the stud 60 during welding. In other cases, the lateral distance can be less than about 18 millimeters, or less than about 15 millimeters, or less than about 12 millimeters from the central axis of the stud during welding. The impediment 74 can be one of an outside edge or convex surface, an inside corner or concave surface, and a second stud previously welded to the workpiece. Various exemplary impediments 74 are illustrated in the drawings. FIG. 9 illustrates the situation where the impediment 274 is a second stud 261 previously welded to the workpiece 262.

FIG. 6 illustrates the situation where the impediment is an outside edge or corner 374 of workpiece 362 and FIG. 7 illustrates the situation where the impediment is an inside corner 474 of workpiece 462. Such outside edge or corner impediments 374 and inside corner impediments 474 can be sharp (i.e., 90 degrees at the corner) or can be radiused, and such edges or corners can circumvent any total angle less than 180 degrees. Such edges or corners 374 and 474 can essentially be defined by a radiused surface. For example, FIG. 5 illustrates a convex surface 174 corresponding to such a convex outside edge impediment of workpiece 162. Similarly, FIG. 8 illustrates a concave surface 574 corresponding to such a convex inside corner impediment of workpiece 562. In both cases, the central axis of the convex surface is aligned with the central axis of the stud being welded, but this need not be the case. Of course, such radiused inside or outside corners can be positioned some lateral distance from the central axis of the stud being welded as indicated previously. Such concave surface impediments 174 can circumvent virtually any angle (as long as a sufficient opening for the flash shield nozzle 132 is provided) and such convex surface impediments 574 can circumvent any angle including 360 degrees (such as a tubular member). In some cases, the radius of such concave or convex surfaces, 174 or 574, respectively, can be less than about 60 millimeters, or less than about 40 millimeters, or less than about 20 millimeters.

The method can include an initial purge period in which gas passes through the screens 34 and flash shield nozzle 32 prior to initiating a series of welding operations. For example, such an initial purge period may be desired if there has been a lapse between welding operations that has exceeded about 10 minutes or greater. In some cases, the length of the initial purge period can be less than about 2 seconds, or less than about 1.5 seconds, or less than about 1 second.

The method can include a pre-flow period in which such gas flow occurs immediately prior to initiating a pilot arc; a weld-flow gas period in which gas flow occurs throughout the primary welding arc; and a post-flow period of gas flow that initiates upon termination of the primary welding arc after a set period of time. In some cases, the combined time period encompassing the pre-flow, weld-flow and post-flow periods can be less than about 2 seconds, or less than about 1.8 seconds, or less than about 1.4 seconds, or less than about 1.2 seconds. Accordingly, very fast weld cycle times can be provided.

The method can, in some cases, further include providing the shielding welding gas through the screens 34 and flash shield nozzle 32 at a flow rate that is at least from about 8 liters per minute, or from about 20 liters per minute, or from about 30 liters per minute; and at a flow rate that is up to about 50 liters per minute, or to about 80 liters per minute. The method can also include passing a total amount of gas through the screens 34 and into the flash shield nozzle 32 throughout the combined pre-flow, weld-flow and post-flow periods that is, in some cases, less than about 1.5 liters, or less than about 1.2 liters, or less than about 1.0 liters, or less than about 0.8 liters.

The foregoing description of the embodiments has been provided for purposes of illustration and description. It is not intended to be exhaustive or to limit the disclosure. For example, one of ordinary skill would appreciate that the screens described herein can encompass wire screens, perforated plates, honeycomb materials, and other functional equivalents for converting the gas flow into a substantially laminar flow state. Similarly, the gap can be an interrupted gap wherein fingers contact the surface of the workpiece, without affecting the flow rate of the gas. In addition, individual elements or features of a particular embodiment are generally not limited to that particular embodiment, but, where applicable, are interchangeable and can be used in a selected embodiment, even if not specifically shown or described. In addition, any description above using a reference numeral of a particular embodiment, can also apply to corresponding components of other embodiments unless context mandates otherwise. The same may also be varied in many ways. Such variations are not to be regarded as a departure from the disclosure, and all such modifications are intended to be included within the scope of the disclosure.

What is claimed is:

1. A drawn arc stud welder nozzle assembly comprising:
a housing supporting a collet and defining a manifold including a plurality of gas passages through the housing;
a flash shield nozzle releasably coupled to the housing and surrounding the collet, the flash shield nozzle including an interior surface having a partial-parabolic-shaped portion;
a plurality of screens supported within the nozzle assembly and positioned so that gas from the manifold flows through the plurality of screens and into the flash shield nozzle;
wherein the collet member is structured to retain a weld stud during drawn arc welding, and wherein a distal end of the collet member extends past the distal end of the flash shield nozzle and any other component of the nozzle assembly to maintain a gap between a workpiece to which the stud is being welded and the nozzle assembly.

2. The drawn arc stud welder nozzle assembly of claim 1, wherein a first side of the screens are retained against an internal annular step of the nozzle assembly.

3. The drawn arc stud welder nozzle assembly of claim 2, wherein the first side of the screens is retained against the internal annular step via a snap ring positioned against a second side of the screens.

4. The drawn arc stud welder nozzle assembly of claim 2, further comprising spacers positioned between the plurality of screens.

5. The drawn arc stud welder nozzle assembly of claim 1, wherein the plurality of screens comprise a first plurality of screens having first size screen openings positioned toward the gas passages, and a second screen having second size screen openings adjacent the first plurality of screens and positioned toward a distal end of the flash shield nozzle, and wherein the first size screen openings are larger than the second size screen openings.

6. The drawn arc stud welder nozzle assembly of claim 1, in combination with a stud welder further comprising a contact probe adjacent the collet at its distal end so that it contacts the workpiece.

7. The drawn arc stud welder nozzle assembly of claim 1, wherein the flash shield nozzle, including the partial-parabolic shaped portion, comprises a non-conductive material.

8. The drawn arc stud welder nozzle assembly of claim 7, wherein the non-conductive material is a high-temperature material capable of withstanding a temperature of at least about 450 degrees F. during welding.

9. The drawn arc stud welder nozzle assembly of claim 1, wherein the screens are supported by the flash shield nozzle and remain coupled to the flash shield nozzle when the flash shield nozzle is removed from the housing, and wherein the screens are removable from the flash shield nozzle while the flash shield nozzle is uncoupled from the housing.

10. The drawn arc stud welder nozzle assembly of claim 9, wherein a first side of the screens is retained against an internal annular step of the flash shield nozzle.

11. The drawn arc stud welder nozzle assembly of claim 10, wherein the first side of the screens are retained against the internal annular step via a snap ring positioned against a second side of the screens.

12. The drawn arc stud welder nozzle assembly of claim 11, further comprising spacers positioned between the plurality of screens.

13. The drawn arc stud welder nozzle assembly of claim 9, wherein screw threads on a surface of the flash shield nozzle engage against cooperating screw threads on an adjacent housing surface to releasably couple the flash shield nozzle to the housing.

14. A drawn arc stud welder method comprising:
welding a stud held within a collet of a drawn arc stud welder nozzle assembly to a workpiece defining an impediment that is a lateral distance of less than about 20 millimeters from a central axis of the stud during welding, wherein the impediment includes one of an outside edge or convex surface, an inside corner or concave surface, and a second stud previously welded to the workpiece.
during the welding the stud, passing a shielding welding gas through a plurality of screens and then into and through a flash shield nozzle surrounding the stud being held within a collet of a drawn arc stud welder nozzle assembly;
maintaining a gap between the workpiece and the nozzle assembly.

15. The drawn arc stud welding method of claim 14, wherein the passing the shielding welding gas through the flash shield nozzle comprises passing the shielding welding gas through the flash shield nozzle including an interior surface having partial-parabolic portion.

16. The drawn arc stud welding method of claim 14, wherein the impediment is an outside edge and the lateral distance from the central axis of the stud to the outside edge is less than about 15 millimeters.

17. The drawn arc stud welding method of claim 14, wherein the impediment is a convex surface comprising a radius of less than about 40 millimeters.

18. The drawn arc stud welding method of claim 14, wherein the impediment is an inside corner and the lateral distance from the central axis of the stud to the inside corner is less than about 18 millimeters.

19. The drawn arc stud welding method of claim 14, wherein the impediment is a concave surface comprising a radius of less than about 40 millimeters.

20. The drawn arc stud welding method of claim 14, wherein the impediment is a second stud previously welded to the workpiece and the lateral distance from the central axis of the stud to a central axis of the second stud is less than about 18 millimeters.

21. The drawn arc stud welding method of claim 14, wherein the passing the shielding welding gas during welding includes passing the gas during a pre-flow period, during a weld-flow period and a during a post-flow period, and wherein a total volume of gas passing into the nozzle during the pre-flow, weld-flow, and post-flow periods is less than about 1.2 liters.

22. The drawn arc stud welding method of claim 21, wherein the total volume of gas passing into the nozzle during the pre-flow, weld-flow, and post-flow periods is less than about 1.0 liter.

23. The drawn arc stud welding method of claim 21, wherein the total volume of gas passing into the nozzle during the pre-flow, weld-flow, and post-flow periods is less than about 0.8 liter.

24. The drawn arc stud welding method of claim 14, wherein the passing the shielding welding gas during welding includes passing the shielding welding gas during a pre-flow period, during a weld flow period and a during a post flow period, and wherein a total time of the pre-flow, weld-flow, and post-flow periods is less than about 2 seconds.

25. The drawn arc stud welding method of claim 24, wherein the total time of the pre-flow, weld-flow, and post-flow periods is less than about 1.4 seconds.

26. The drawn arc stud welding method of claim 24, wherein the total time of the pre-flow, weld-flow, and post-flow periods is less than about 1.2 seconds.

27. The drawn arc stud welding method of claim 14, wherein the passing the shielding welding gas during welding includes passing the gas into and through the nozzle at a flow rate that is between about 20 liters per minute and about 80 liters per minute.

28. The drawn arc stud welding method of claim 27, wherein the flow rate is between about 30 liters per minute and about 50 liters per minute.

29. The drawn arc stud welding method of claim 14, further comprising passing the shielding welding gas through the plurality of screens and then into and through the nozzle during an initial purge period prior to the welding of an initial stud, wherein the initial purge period is less than about 2 seconds.

30. The drawn arc stud welding method of claim 29, wherein the initial purge period is less than about 1.5 seconds.

31. The drawn arc stud welding method of claim 29, wherein the initial purge period is less than about 1 second.
